(19) United States
(12) Patent Application Publication
(10) Pub. No.: US 2009/0147145 A1
(43) Pub. Date: Jun. 11, 2009

(54) ON SCREEN DISPLAY INTERFACE FOR DIGITAL BROADCAST RECEIVING DEVICE

(75) Inventors: Tae-young LEE, Suwon-si (KR); Jae-young KWAK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/166,426

(22) Filed: Jul. 2, 2008

(30) Foreign Application Priority Data
Dec. 11, 2007 (KR) 10-2007-0128186

(51) Int. Cl. H04N 5/44

(52) U.S. Cl. 348/725; 348/E05.096

(57) ABSTRACT

An interface through which a decoder chip, which pre-processes an image, transmits on screen display (OSD) data to a display chip, which post-processes the image, in a digital broadcast receiving device. The decoder chip generates and transmits an interrupt to the display chip which operates as a host, and when a read command is received from the display chip, the decoder chip reads OSD data from an external memory so as to transmit the OSD data to the display chip. Accordingly, OSD data can be transmitted to the display chip operating as a host using a path different from the image data path.

### CROSS-REFERENCE TO RELATED PATENT APPLICATION

This application claims the benefit of Korean Patent Application No. 10-2007-0128186, filed on Dec. 11, 2007 in the Korean Intellectual Property Office, the disclosure of which is incorporated herein in its entirety by reference.

### BACKGROUND OF THE INVENTION

1. Field of the Invention

The present invention relates to a digital broadcast receiving device, and more particularly, to an interface for on screen display (OSD) data in a digital broadcast receiving device such as a digital television (TV) or a set-top box.

2. Description of the Related Art

In general, a digital TV (D-TV) comprises a decoder chip which is a front-end processing module decoding an image source, and a display chip which is a back-end processing module processing the decoded image frame and outputting the same to a display panel.

FIG. 1A is a schematic diagram for explaining a decoder chip and a display chip of a general D-TV.

The decoder chip receives a video stream having an MPEG-1/2 or H.264 format from a tuner and decodes the video stream and stores it in an external memory. Also, on screen display (OSD) data (graphic data) is stored in the external memory as well.

However, image data and OSD data are transferred using different paths. In other words, image data is transmitted through an image interface for image data such as BT.656, BT.601, etc. to the display chip. On the other hand, OSD data is written by a host central processing unit (CPU) to the display chip of the decoder chip by using a host interface. Here, a host interface means an ordinary interface through which control signals such as address, data, output enable (OE), write enable (WE), chip select (CS), etc. are transmitted.

Image data and OSD data are post-processed in the display chip and then mixed in a mixer and output to a display panel.

FIGS. 1B and 1C are schematic diagrams for explaining a data processing method when a display chip which does not provide a slave interface (I/F) is used in a D-TV.

During an OSD data transmission, if a slave I/F, which can be connected to a CPU host in a display chip as illustrated in FIG. 1A, is provided, there is no problem. However, if the display chip does not provide a slave I/F and operates as a host as illustrated in FIG. 1B, a connection between hosts is impossible. In other words, a data write path and a subsequent data processing path which are denoted with a short dotted line cannot be processed. Accordingly, unless another transmission path is provided, OSD data and image data must be mixed in the decoder chip through a path denoted with a long dotted line and then transmitted to the display chip through an image interface. In this case, when back-end processes such as scaling, deinterlacing, etc. are performed, image quality of a graphic screen may be deteriorated by OSD data. Therefore, in order to prevent such image quality deterioration, OSD data needs to be transmitted through a different path from image data, and OSD data and image data should be separated in the display chip to be post-processed.

Obviously, this problem can be solved when OSD data is transmitted through an additional interface between the decoder chip and the display chip. In the D-TV illustrated in FIG. 1C, a dual port static random access memory (SRAM) is used between host interfaces of the decoder chip and the display chip so that the decoder chip writes graphic data to a SRAM and the display reads graphic data from the SRAM. However, since a dual-port SRAM is required, the manufacturing cost of the digital TV increases significantly.

### SUMMARY OF THE INVENTION

The present invention provides an on screen display (OSD) interface capable of transmitting OSD data between a decoder chip and a display chip, having only host interfaces, in a digital broadcast receiving device.

According to an aspect of the present invention, there is provided a method, performed by a first chip, of decoding a broadcasting video source, transmitting additional data to a second chip, which outputs decoded video to a display panel, the method comprising: generating and transmitting an interrupt to the second chip; receiving a read command from the second chip to read date from an external memory; and obtaining the data from the external memory and transmitting the additional data obtained from the external memory based on the read command as the additional data.

The additional data may be on screen display (OSD) data.

The transmitting may comprise: if one of data blocks constituting the additional data is transmitted, writing status information to a register, which indicates whether an error is present in the transmitted data block; and re-transmitting the data block or transmitting a next data block or finishing transmission of the data blocks, based on control information written to the register by the second chip after the second chip has read the status information.

The first chip may distinguish between the read command to read the data from the external memory, and a read/write command in relation to the register, by using a 2-bit address signal, and addresses of the external memory and the register are sequentially increased every time the data blocks and the status information are read, respectively.

According to another aspect of the present invention, there is provided a computer-readable recording medium on which a computer program for executing the method of transmitting additional data is recorded.

According to another aspect of the present invention, there is provided an apparatus for transmitting additional data to a display chip receiving a decoded broadcasting video and outputting it to a display panel, the apparatus comprising: an interrupt generating unit which generates and transmits an interrupt to the display chip; and a data interface unit, if a read command to read data from an external memory is received from a second chip which obtains the data from the external memory and which transmits the additional data obtained from the external memory to the second chip based on the read command as the additional data.

The additional data may be on screen display (OSD) data.

The data interface unit may comprise: a register control unit which, if one of data blocks constituting the additional data is transmitted, writes status information to a register, wherein the status information indicates whether an error is present in the transmitted data block; and a transmission control unit which re-transmits the data block or which transmits a next data block or which finishes transmission of the data blocks, based on control information written to the register by the second chip after the second chip has read the status information.

The data interface unit may distinguish between a read command to read the data from the external memory or a read/write command in relation to the register using a 2-bit address signal, wherein addresses of the external memory and the register are sequentially increased every time the data blocks and the status information are read, respectively.

### BRIEF DESCRIPTION OF THE DRAWINGS

The above and other features and advantages of the present invention will become more apparent by describing in detail exemplary embodiments thereof with reference to the attached drawings in which:

FIGS. 1A, 1B, and 1C illustrate configurations of a conventional digital TV;

FIG. 2 is a schematic view of a configuration of a digital TV, according to an embodiment of the present invention;

FIG. 3 is a flowchart illustrating the operation of a decoder chip according to an exemplary embodiment of the present invention;

FIG. 4 is a flowchart illustrating the operation of a decoder chip and a display chip in a digital TV according to an exemplary embodiment of the present invention;

FIG. 5 is a table showing address signals according to an exemplary embodiment of the present invention;

FIG. 6 is a flowchart illustrating the process of a decoder chip reading a data block according to an exemplary embodiment of the present invention;

FIG. 7 is a flowchart illustrating the process of a decoder chip reading status information according to an exemplary embodiment of the present invention;

FIG. 8 is a schematic view of a configuration of a decoder chip according to an exemplary embodiment of the present invention; and

FIG. 9 is a schematic view of a configuration of a decoder chip according to another exemplary embodiment of the present invention.

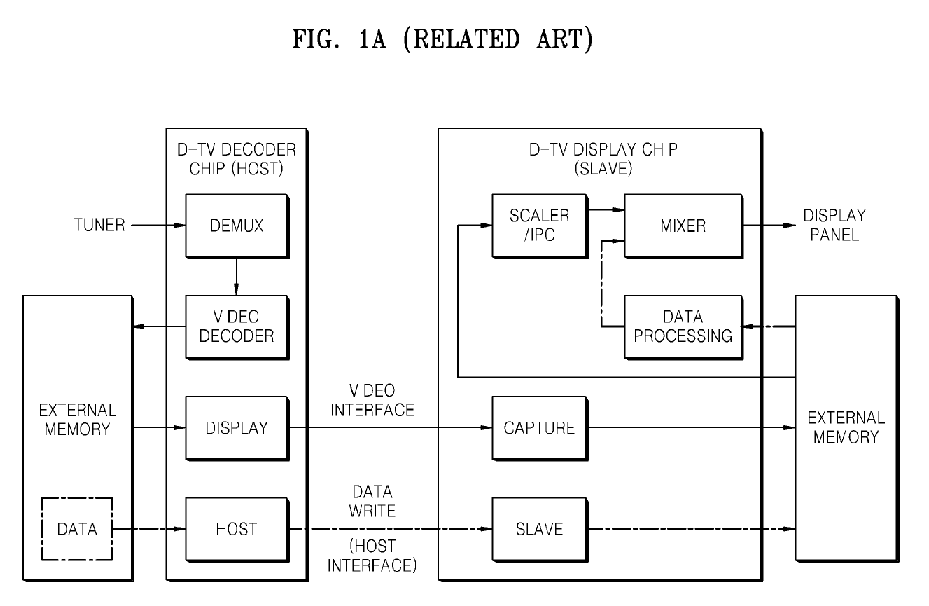

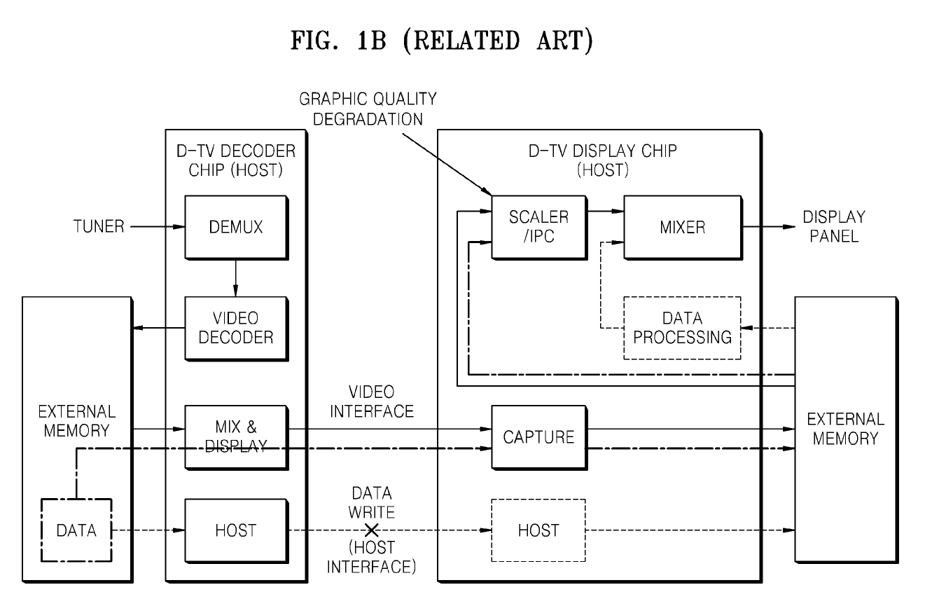

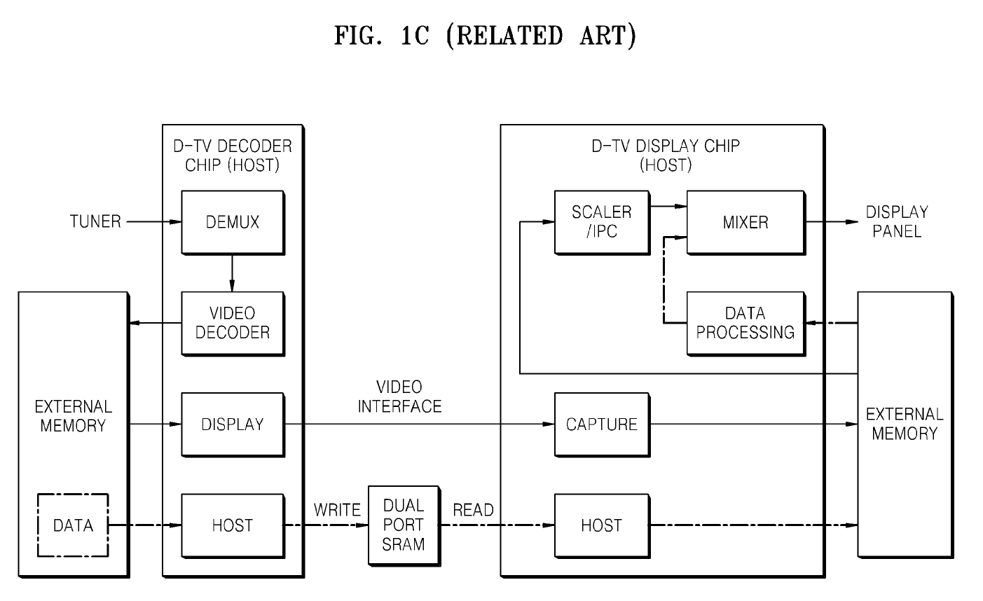

### DETAILED DESCRIPTION OF THE INVENTION

The present invention will now be described more fully with reference to the accompanying drawings, in which exemplary embodiments of the invention are shown.

Hereinafter, data transmitted by a decoder chip to a display chip is illustrated as on screen display (OSD) data; however, the present invention can also be applied to various additional types of data other than OSD data which a decoder chip has to transmit to a display chip.

In addition, a digital broadcast receiving device will be illustrated as a digital TV (D-TV), hereinafter, and a decoder chip and a display chip will be assumed to be mounted in the D-TV. However, the present invention can also be applied to other various digital broadcast receiving devices, for example a set-top box, besides a D-TV. Also, a decoder chip and a display chip remain in the range of the present invention even when they are not necessarily mounted in one independent device.

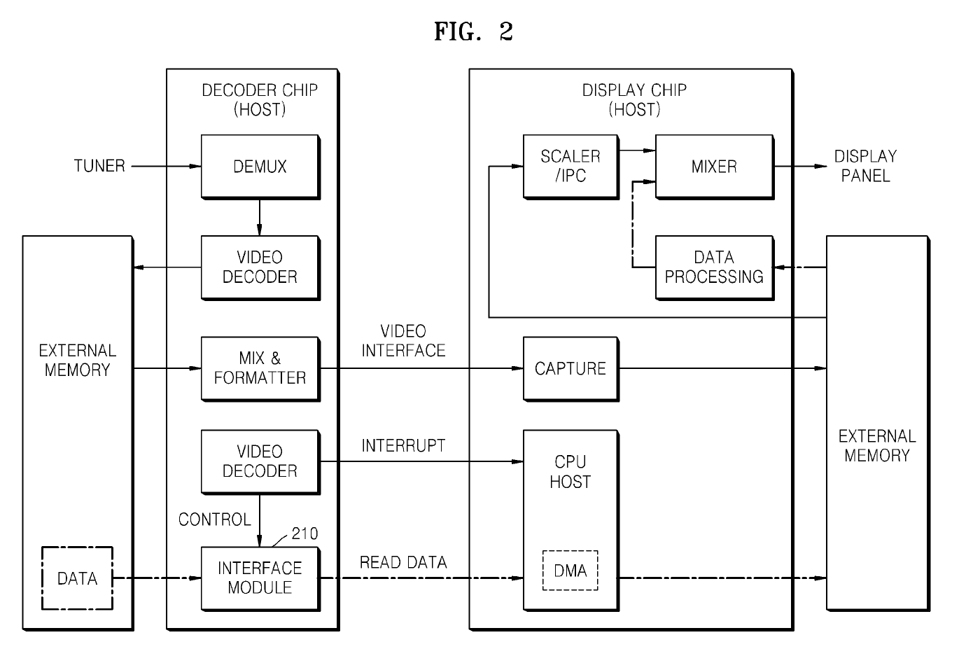

FIG. 2 is a block diagram of a configuration of a D-TV according to an exemplary embodiment of the present invention.

As illustrated in FIG. 2, a decoder chip of the digital TV according to the current embodiment of the present invention comprises an interface module 210 for OSD data. A central processing unit (CPU) of a display chip reads OSD data of an external memory by using the interface module 210. Also, image data is transmitted to the display chip using another image interface.

The decoder chip generates and transmits an interrupt to the CPU of the display chip if there is OSD data to be transmitted to the display chip. When an interrupt is generated, the display chip executes a predefined interrupt routine to read OSD data using the interface module 210 of the decoder chip. The display chip may use direct memory access (DMA) for high speed transmission. Image data that is post-processed through a different path and OSD data are mixed in a mixer and then output to a display panel. The process of the display chip reading OSD data will be described in detail later.

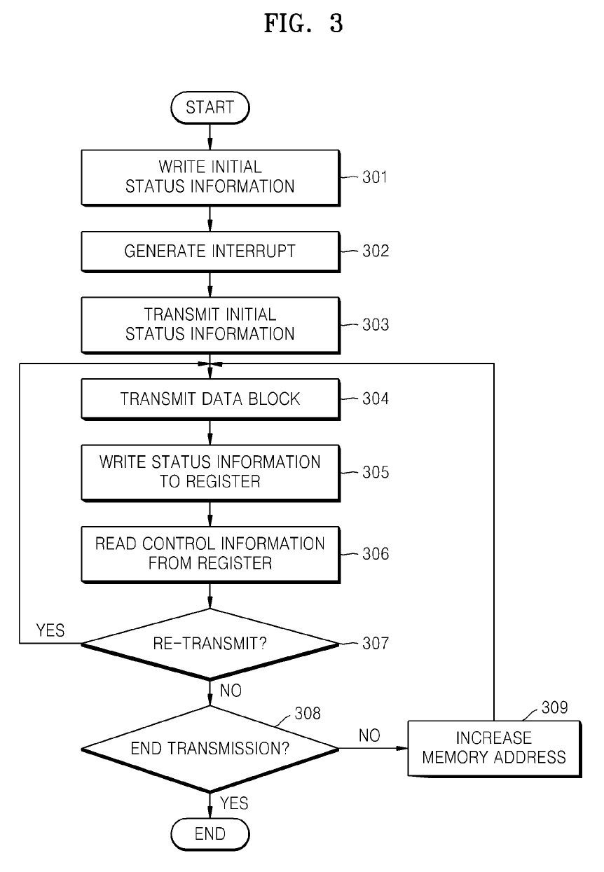

FIG. 3 is a flowchart illustrating the operation of a decoder chip according to an exemplary embodiment of the present invention.

The decoder chip includes a register to which status information and control information are written. The status information is information about OSD data the decoder chip transmits to a display chip and information indicating whether an error exists in the transmitted data. The status information is written by a CPU of the decoder chip. Control information is information a CPU of a display chip is written to a register for reading OSD data stored in an external memory using an interface module of the decoder chip.

In operation 301, the decoder chip writes initial status information to a register. The initial status information includes an initial address of an external memory, the size of OSD data transmitted to the display chip, the size of a data block which is a unit of retransmission, etc.

In operation 302, the decoder chip generates and transmits an interrupt to the display chip so that the display chip executes an interrupt routine for reading OSD data.

In operation 303, the decoder chip transmits initial status information to the display chip. In other words, the display chip reads the register of the decoder chip to obtain initial status information.

In operation 304, the decoder chip reads data corresponding to one data block from an external memory and transmits it to the display chip. In operation 304, the operation of the decoder chip corresponds to a read command of the display chip. Control signals displaying such a read command include an address signal. The address signal does not indicate the specific address of the external memory. Instead, it is preferable that the decoder chip reads the external memory by sequentially increasing the address internally. Accordingly, the number of bits of the address signal can be reduced, and consequently, an interface for transmission of the address signal can be realized by using a small number of bits.

In operation 305, the decoder chip writes status information to the register. The status information indicates whether there is an error in the data block that is transmitted in operation 304. After the display chip has read one data block completely, the display chip determines whether there is an error in the received data block by reading the register, and writes control information indicating whether to re-transmit the received data block, to the register of the decoder chip.

In operation 306, the decoder chip reads the control information written by the display chip to the register.

In operation 307, the control information is read to determine whether to re-transmit the data block that is most recently transmitted to the display chip. If the control information indicates re-transmission, operation 304 and the operations thereafter are executed again. If no re-transmission is indicated, the process proceeds to operation 308.

In operation 308, the decoder chip determines whether the control information indicates an end of transmission. When all blocks up to the last memory block are transmitted, the display chip writes control information indicating the transmission end, and thus transmission is ended accordingly. If no transmission end is indicated, the address of the memory is increased in operation 309 to read a next memory block and operation 304 and the operations thereafter are executed again. That is, when the decoder chip reads the address of the memory sequentially as described above, the display chip does not have to indicate the address of the memory through the address signal.

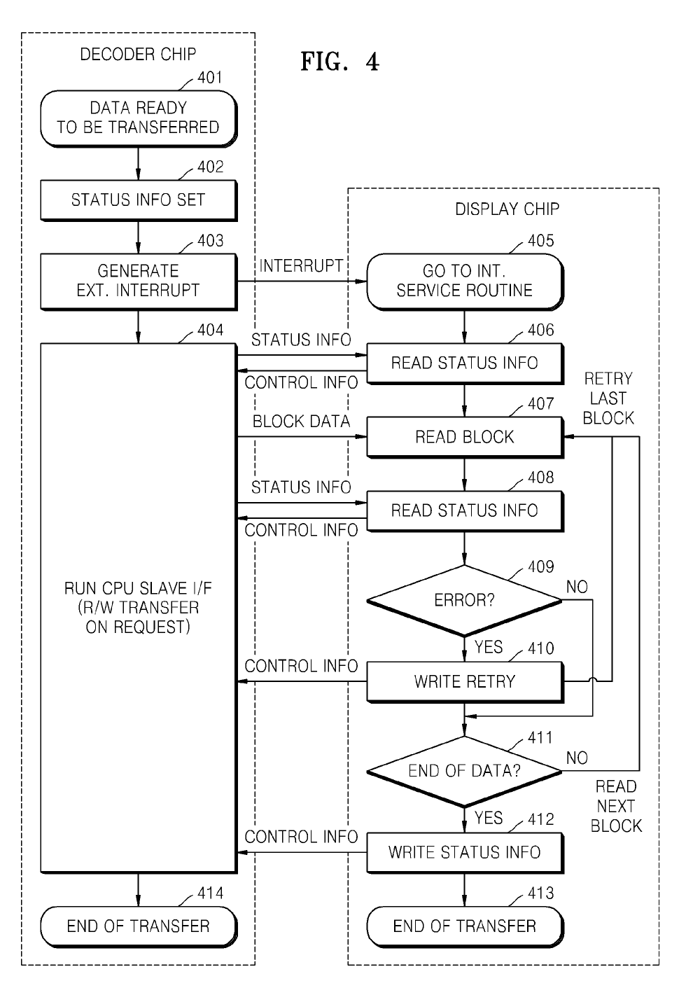

FIG. 4 is a flowchart illustrating the operation of a decoder chip and a display chip of a digital TV according to an exemplary embodiment of the present invention.

In operation 401, the decoder chip writes OSD data to be transmitted to the display chip, to an external memory.

In operation 402, the decoder chip writes initial status information to a register. As described above, the initial status information indicates an initial address, the size of data to be transmitted, the size of a data block which is a unit of retransmission, etc.

In operation 403, the decoder chip generates an external interrupt to inform the display chip that there is OSD data to be transmitted.

In operation 404, the decoder chip runs an interface module according to the current exemplary embodiment of the present invention to be on standby for a read/write command of the display chip.

In operation 405, the display chip recognizes the external interrupt and executes an interrupt service routine.

In operation 406, the display chip reads status information from the register of the decoder chip. The status information is initial status information. That is, in operation 406, the display chip checks the size of OSD data and the size of the data block, etc. After reading the status information, the display chip writes control information to the register to inform the decoder chip that the display chip has read the status information.

In operation 407, the display chip reads one data block through an interface module of the decoder chip and stores the data block in the external memory. The external memory is a memory that is used by the display chip for back-end processing of image data and OSD data.

Meanwhile, there might be an error such as first in-first out (FIFO) underflow in the transmitted data block according to the internal bus situation of the decoder chip. Although not illustrated in the drawing, in this case, the decoder chip writes status information indicating a transmission error, to the register.

In operation 408, the display chip reads status information from the register of the decoder chip. Here, even when the display chip does not specify an address of the register to read status information, it is preferable that the decoder chip reads the address of the register by sequentially increasing the address of the register internally.

After reading status information, control information indicating that status information has been read is written to the register.

In operation 409, the display chip analyzes the status information to determine whether there is an error in the most recently read data block. If there is no error, it proceeds to operation 411.

In operation 410, if the status information shows an error, the display chip writes re-transmission control information indicating that the corresponding data block is to be read again, to the register of the decoder chip, and operation 407 and the operations thereafter are performed again. If re-transmission control information is written, the decoder chip reads the most recently read data block again and transmits it to the display chip in operation 407.

In operation 411, the display chip determines whether transmission of OSD data is completed with reference to the initial status information read in operation 406. If transmission of OSD data is not complete, operation 407 and the operations thereafter are performed with respect to a next data block.

In operation 412, if OSD data is read completely, control information indicating transmission end is written to the register of the display chip.

In operation 413, the display chip ends the interrupt service routine, and in operation 414, the decoder chip also ends data transmission after reading the control information.

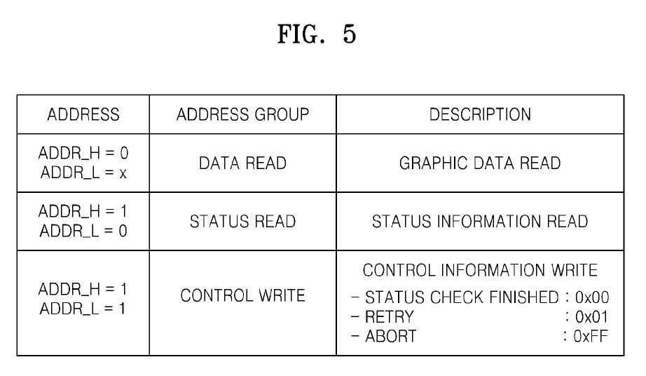

FIG. 5 is a table showing address signals according to an embodiment of the present invention.

An address signal, which is used for the display chip to give a read/write command to the decoder chip, may be minimized to 2, bits as illustrated in FIG. 5.

According to the current exemplary embodiment, when the address signal is 0x, the address signal indicates a read command to read OSD data (graphic data). However, as described above, the decoder chip should read OSD data by sequentially increasing the address of the memory internally.

When the address signal is 10, the address signal indicates a read command to read status information. Here, the decoder chip should read the status information by sequentially increasing the address of the register internally.

If the address signal is 11, the address signal indicates a write command instructing to write control information. In this case, the type of control information need not be classified using the address signal, but can be classified using data written to the register. As shown in FIG. 5, it can be determined by the decoder chip and the display chip in advance that, for example, 0 x 00 denotes control information for informing that the display chip has read status information, that 0 x 01 denotes control information requesting re-transmission because of an error in the transmitted data block, and that 0 x FF denotes control information indicating transmission end.

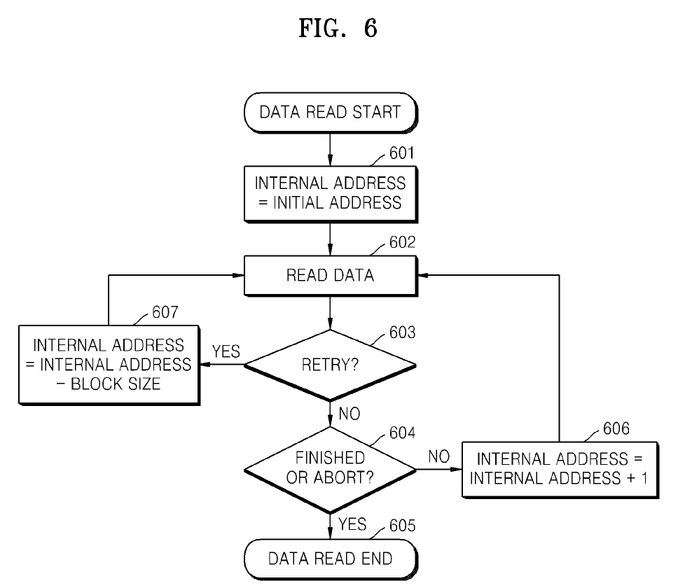

FIG. 6 is flowchart illustrating the process of a decoder chip reading a data block according to an exemplary embodiment of the present invention.

In operation 601, the decoder chip sets an initial address which is shown by the initial status information, as an internal address.

In operation 602, the decoder chip reads one data unit, starting from the initial address. If an interface for data transmission between a decoder chip and a display chip is 8 bits (1 byte), then the unit of data is a byte.

In operation 603, the decoder chip checks whether control information that requests re-transmission is written to the register to determine whether to re-transmit.

In operation 604, if no re-transmission is requested, it is checked whether control information indicating transmission end is written to the register. When the control information indicating transmission end is written, the process proceeds to operation 605 to end transmission. If control information indicating transmission end is not written, the process proceeds to operation 606.

In operation 606, the internal address is increased by 1 (byte) in order to read a next data block. In other words, according to the current exemplary embodiment, it is assumed that an interface for data transmission between the decoder chip and the display chip is 8 bits (1 byte). Accordingly, when the size of a data block is n bytes, the decoder chip must perform n data transmissions to transmit one data block to the display chip.

In operation 607, if re-transmission is requested, the most recently transmitted data block should be transmitted again from the starting address, and thus the size of the data block is subtracted from the current internal address to calculate which address of the memory should be the starting point for reading.

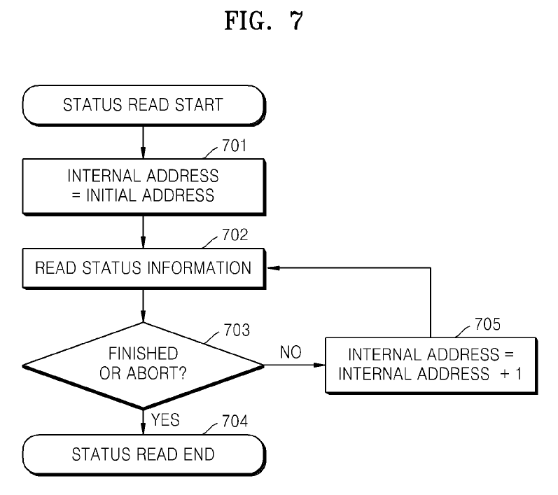

FIG. 7 is a flowchart illustrating the process of a decoder chip reading status information according to an exemplary embodiment of the present invention. That is, when a read command instructing to read a register is received from a display chip, the decoder chip reads status information from the register according to the following process, and then transmits the status information to the display chip.

In operation 701, the decoder chip sets an initial address of the register, that is, an address in which initial status information is written, as an internal address. While the internal address of FIG. 6 concerns the external memory, the internal address of FIG. 7 concerns the register.

In operation 702, status information is read. The read status information is transmitted to the display chip.

In operation 703, it is determined whether reading of the status information is ended. Whether reading of the status information is ended or not can be determined with reference to control information written to the register by a write command of the display chip. If there is no need to read status information any more, the process proceeds to operation 704 to end reading.

In operation 705, if status information has to be read again, the address of the register is sequentially increased internally.

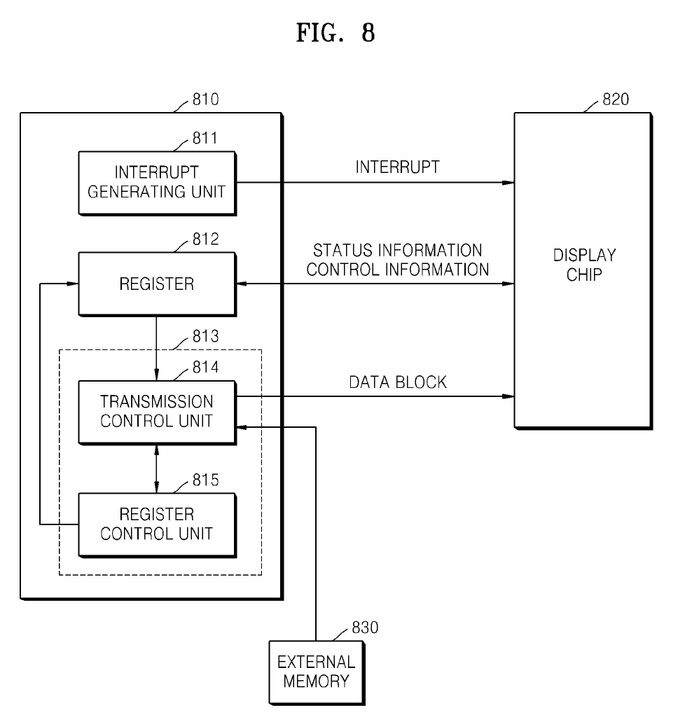

FIG. 8 is a schematic view of a configuration of a decoder chip 810 according to an exemplary embodiment of the present invention.

As illustrated in FIG. 8, the decoder chip 810 comprises an interrupt generating unit 811, a register 812, and a data interface unit 813.

The interrupt generating unit 811 generates an interrupt when there is OSD data to be transmitted to a display chip 820.

Status information, which indicates a transmission state of OSD data, and control information, which is used by the display chip 820 to control the decoder chip 810, are written to the register 812.

The data interface unit 813 performs a read/write operation from/to the register 812 and an external memory 830 according to a read/write command of the display chip 820 and transmits OSD data to the display chip 820.

As described above, the data interface unit 813 may preferably sequentially increase a memory address and a register address every time when reading a data block and status information from the external memory 830 and the register 812. In this case, the display chip 820 does not require specific addresses for a read command about the external memory 830 or a read/write operation about the register 812, and thus the address signal of 2-bits is sufficient.

The data interface unit 813 comprises a transmission control unit 814 and a register control unit 815. The register control unit 815 writes initial status information displaying the size of OSD data, etc. to the register 812. Also, the data interface unit 813 writes, if a data block is transmitted, status information indicating whether there is error in the transmitted data block, to the register 812.

The transmission control unit 814 reads a data block from the external memory 830 and transmits it to the display chip 820. Also, the transmission control unit 814 re-transmits the data block based on control information written to the register 812 by the display chip 820.

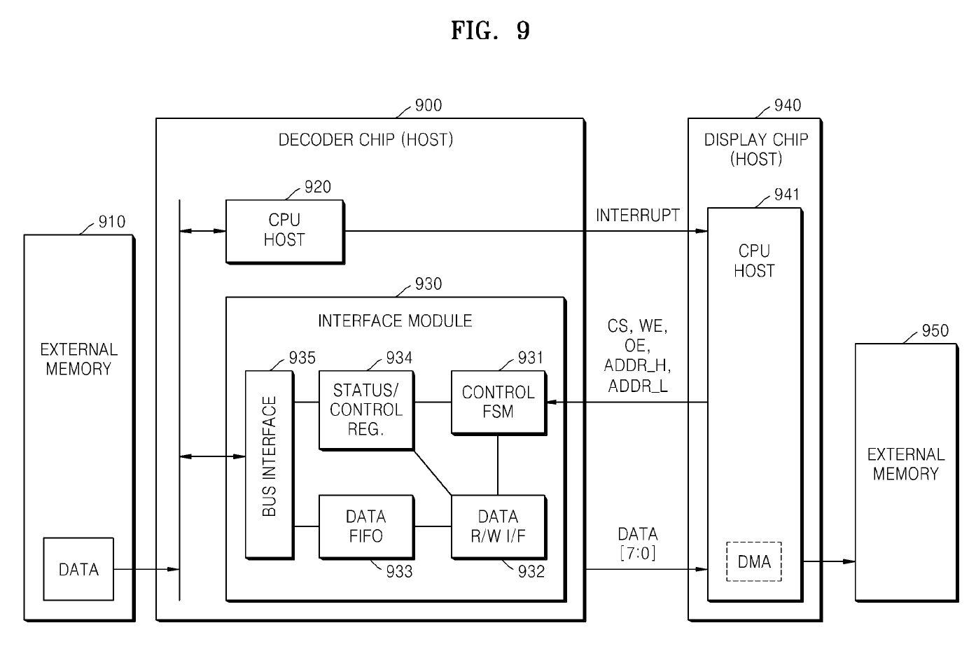

FIG. 9 is a schematic view of a configuration of a decoder chip 900 according to another exemplary embodiment of the present invention.

The decoder chip 900 according to the current exemplary embodiment of the present invention comprises a CPU 920 and an interface module 930; the interface module 930 comprises a control finite state machine (FSM) 931, a data read/write (R/W) interface 932, a data FIFO storage unit 933, a register 934, and a bus interface 935.

The CPU 920 writes an initial status signal to the register 934 when OSD data is provided, and generates and transmits an interrupt to a CPU 941 of a display chip 940.

The control FSM 931 controls a read/write operation of the data R/W interface 932 according to control information of the register 934 and chip select (CS), write enable (WE), output enable (OE), and address signals transmitted from the display chip 940 having external memory 950.

The data RW interface 932 performs a read/write operation from/to the status/control register 934 or the data FIFO storage unit 933 according to the controlling of the control FSM 931.

The data FIFO storage unit 933 is a temporary storage unit for storing OSD data read from an external memory 910 before transmitting it to the display chip 940.

The bus interface 935 provides the function of reading data from the external memory 910 and the function of allowing the CPU 920 of the decoder chip 900 to read/write with respect to the register 934. In the decoder chip 900 having the above configuration, the transmission speed of data is determined by a reading speed in the display chip, and as there is no internal bottle-neck, so high speed data transmission is possible.

The embodiments of the present invention can be written as computer programs and can be implemented in general-use digital computers that execute the programs using a computer readable recording medium.

Examples of the computer readable recording medium include read-only memory (ROM), random-access memory (RAM), CD-ROMs, magnetic tapes, floppy disks, and optical data storage devices. In another exemplary embodiment, the computer readable recording medium may include carrier waves (such as data transmission through the Internet).

According to the present invention, various additional data can be transmitted at high speed from a decoder chip to a display chip which operates as a host, in a digital broadcast receiving device. In particular, in the case where the additional data is OSD data, the problem of image quality deterioration can be prevented.

Also, when transmitting a read/write command of the display chip, the number of bits needed for an address signal can be minimized, thereby reducing manufacturing costs.

While the present invention has been particularly shown and described with reference to exemplary embodiments thereof, it will be understood by those of ordinary skill in the art that various changes in form and details may be made therein without departing from the spirit and scope of the present invention as defined by the following claims. The embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method, performed by a first chip, of decoding a broadcasting video source, transmitting additional data to a second chip, which outputs decoded video to a display panel, the method comprising:
generating and transmitting an interrupt to the second chip;
receiving a read command from the second chip to read data from an external memory; and
obtaining the data from the external memory and transmitting the data obtained from the external memory based on the read command as the additional data.

2. The method of claim 1, wherein the additional data is on screen display (OSD) data.

3. The method of claim 1, wherein the transmitting comprises:
if one of data blocks constituting the additional data is transmitted, writing status information to a register, which indicates whether an error is present in the transmitted data block; and
re-transmitting the data block or transmitting a next data block or finishing transmission of the data blocks, based on control information written to the register by the second chip after the second chip has read the status information.

4. The method of claim 3, wherein the first chip distinguishes between the read command to read the data from the external memory, and a read/write command in relation to the register, by using a 2-bit address signal, and
wherein addresses of the external memory and the register are sequentially increased every time the data blocks and the status information are read, respectively.

5. An apparatus for transmitting additional data to a display chip receiving a decoded broadcasting video and outputting it to a display panel, the apparatus comprising:
an interrupt generating unit which generates and transmits an interrupt to the display chip; and
a data interface unit which, if a read command to read data from an external memory is received from a second chip which obtains the data from the external memory and which transmits the data obtained from the external memory to the second chip based on the read command as the additional data.

6. The apparatus of claim 5, wherein the additional data is on screen display (OSD) data.

7. The apparatus of claim 5, wherein the data interface unit comprises:
a register control unit which, if one of data blocks constituting the additional data is transmitted, writes status information to a register, wherein the status information indicates whether an error is present in the transmitted data block; and
a transmission control unit which re-transmits the data block or which transmits a next data block or which finishes transmission of the data blocks, based on control information written to the register by the second chip after the second chip has read the status information.

8. The apparatus of claim 3, wherein the data interface unit distinguishes between a read command to read the data from the external memory and a read/write command in relation to the register using a 2-bit address signal, and
wherein addresses of the external memory and the register are sequentially increased every time the data blocks and the status information are read, respectively.

9. A computer-readable recording medium having a computer program recorded thereon, the computer program for causing a computer to execute the method of claim 1.
